(19) United States
(12) Patent Application Publication
(10) Pub. No.: US 2010/0284346 A1
(43) Pub. Date: Nov. 11, 2010

(54) System and method for cell-edge performance management in wireless systems using centralized scheduling

(76) Inventors: Ashok N. Rudrapatna, Basking Ridge, NJ (US); Ganapathy S. Sundaram, Hillsborough, NJ (US); Subramanian Vasudevan, Morristown, NJ (US); Jialin Zou, Randolph, NJ (US)

Correspondence Address: Docket Administrator (Room 2F-192);Alcatel Lucent, 600 Mountain Avenue, Murray Hill, NJ, 07974-0636, US

(21) Appl. No.: 12/455,220

(22) Filed: May 30, 2009

Related U.S. Application Data
(60) Provisional application No. 61/216,002, filed on May 11, 2009.

(51) Int. Cl. H04W 72/04

(52) U.S. Cl. 370/329

(57) ABSTRACT

A method is provided for scheduling transmission resources to a mobile station served by a plurality of base stations. According to the method of the invention, a centralized scheduler is provided at a network node operative to serve each of the plurality of base stations and the centralized scheduler acts to prioritize scheduling of transmission resources to the mobile station as a function of feedback information respecting data received by the mobile station from each of at least two of the plurality of base stations.

### RELATED APPLICATIONS

This application claims priority pursuant to 35 U.S.C. Sec 119(e) to U.S. Provisional Application No. 61/216,002, filed May 11, 2009, entitled “SYSTEM AND METHOD FOR CELL-EDGE PERFORMANCE MANAGEMENT IN WIRELESS SYSTEMS,” the subject matter thereof being fully incorporated herein by reference. The disclosed invention is related to U.S. patent application Ser. No. 12/______, filed concurrently herewith, entitled “SYSTEM AND METHOD FOR CELL EDGE PERFORMANCE MANAGEMENT IN WIRELESS SYSTEMS USING DISTRIBUTED SCHEDULING” which is assigned to the same assignee and is incorporated herein by reference

### FIELD OF THE INVENTION

The present invention generally relates to cell-edge performance management in wireless systems.

### BACKGROUND OF THE INVENTION

In wireless communications, users situated relatively far from a base station that serves them are generally more susceptible to interference from neighboring base stations and to signal attenuation. As a consequence, such users may experience relatively low signal-to-interference-and-noise ratios (SINRs), and thus typically receive much lower data rates than users located nearer to the base station. The relatively distant users are referred to as “cell edge users” or as users with “poor geometry.” It will be understood that when one user is said to be more “distant” from the base station than another, what is meant does not depend solely on geographical distance, but also to susceptibility to other factors leading to attenuation and interference. It is noted that the terms “user” and “mobile station” are generally used interchangeably herein to denote a mobile entity or device operative to exchange communications signals with the wireless communication system. Any deviation from such interchangeability should be apparent from the context.

Wireless packet data systems of the current art (for example, systems implemented according to the Evolution-Data Optimized (EV-DO), High Speed Packet Access (HSPA), or Worldwide Interoperability for Microwave Access (WiMAX) wireless protocols)), as well as those projected for deployment in the near future, such as the 3GPP Long Term Evolution (LTE) project), use schedulers located at base stations to determine transmission timing and format—including data rate, modulation and coding rates, power and frequency allocation—for data transmissions to the mobile users. Based on channel quality feedback from the mobile stations, the schedulers attempt to transmit to users in a manner to take advantage of favorable quality conditions in these channels. Further these schedulers implement scheduling algorithms for balancing the competing demands of all the users seeking to receive data from each base station, using fairness criteria that take into account, for example, the throughputs and latencies experienced by the users.

A significant performance issue, however, associated with wireless packet data systems is the great disparity between the data rates that are achievable for users near the base station sites and those users that are further away at the cell edge.

To some degree, the poorer channel quality typically experienced by mobile users at the cell edge is mitigated by increasing transmit power and bandwidth at the base station and by the addition of multiple antennas at the base station to support multiple data stream transmission and/or beam-forming to the mobile station. Nonetheless, even with such signal quality enhancements, those mobile stations at the cell edge are still limited to low data rates and cannot realize the quality of service required for newer, low-latency, high data-rate wireless applications. Moreover, even to the degree the mitigation steps described here improve throughput for cell-edge users, they also tend to further improve throughput for users better positioned in the cell, so that the problem of disparity in throughput between cell-edge and other users remains largely unaddressed.

### SUMMARY OF INVENTION

One embodiment of the present invention provides a method for scheduling transmission resources to a mobile station served by a plurality of base stations. According to the method of the invention, a centralized scheduler is provided at a network node operative to serve each of the plurality of base stations and the centralized scheduler acts to prioritize scheduling of transmission resources to the mobile station as a function of feedback information respecting data received by the mobile station from each of at least two of the plurality of base stations.

### BRIEF DESCRIPTION OF THE FIGURES

The teachings of the present invention can be readily understood by considering the following detailed description in conjunction with the accompanying drawings, in which:

FIG. 1 schematically depicts a wireless system architecture in which the invention can be implemented

FIG. 2 schematically depicts the wireless system architecture of FIG. 1 modified to include invention components

### DETAILED DESCRIPTION

The relatively poor channel quality available to mobile users at the cell edge has generally been addressed in the art through, in effect, trading aggregate cell throughput for performance improvements at the cell edge. Basically, in that approach, the schedulers give more scheduling opportunities to cell edge users thereby increasing the data rates available to them. Alternatively, schedulers may use minimum throughput requirements and increase the number of scheduling instances of cell-edge users in order to improve cell-edge performance. Such rules however constrain scheduler choices and thereby lower overall cell throughput.

Another approach to increasing cell edge throughput is realized in a family of coordinated multi-point transmission schemes (such as Network MIMO) that, in effect, schedule data transmissions centrally for transmission from multiple base station antennas in a coherent combining manner of such transmissions as received by the mobile stations. Such schemes are, however, extraordinarily complex and impose significant bandwidth and latency requirements on the network. They further require tight timing and phase synchronization across antennas of different base stations, as well as a significant amount of channel state feedback from the mobile stations. As a result, these solutions are generally not considered viable for the downlink of cellular systems in the near future.

The inventors have developed, and disclose herein, a system and method that provides a significant improvement in throughput for mobile stations at the cell edge, while at the same time increasing aggregate base station throughput. Thus, with the invention, cell edge performance need no longer be traded for sector throughput; rather, application of the invention for serving cell edge users additionally helps increase overall sector throughput. Moreover, the system and method of the invention avoids the drawbacks of known coordinated multi-point schemes (e.g., Network MIMO).

As a predicate to describing the invention embodiments, it is noted that cell edge users are usually located in zones (typically called handoff zones) where they can potentially receive data from more than one base station. These base stations (and their associated schedulers) are each able to schedule transmissions to these mobile stations, but can do so only in an uncoordinated fashion. Thus, the basic service arrangement in a given wireless cell/sector is one where users that are close in to the base station are typically scheduled by a single base station while those in handoff regions are scheduled by multiple base stations. Those mobile stations located in a handoff region, and receiving data from multiple base stations, will need to provide channel-state feedback associated with data transmissions from each of these base stations for enabling the scheduling decisions at the respective base stations. Correspondingly, these mobile stations must be capable of monitoring the downlink control channels and receiving control signals from each of these base stations.

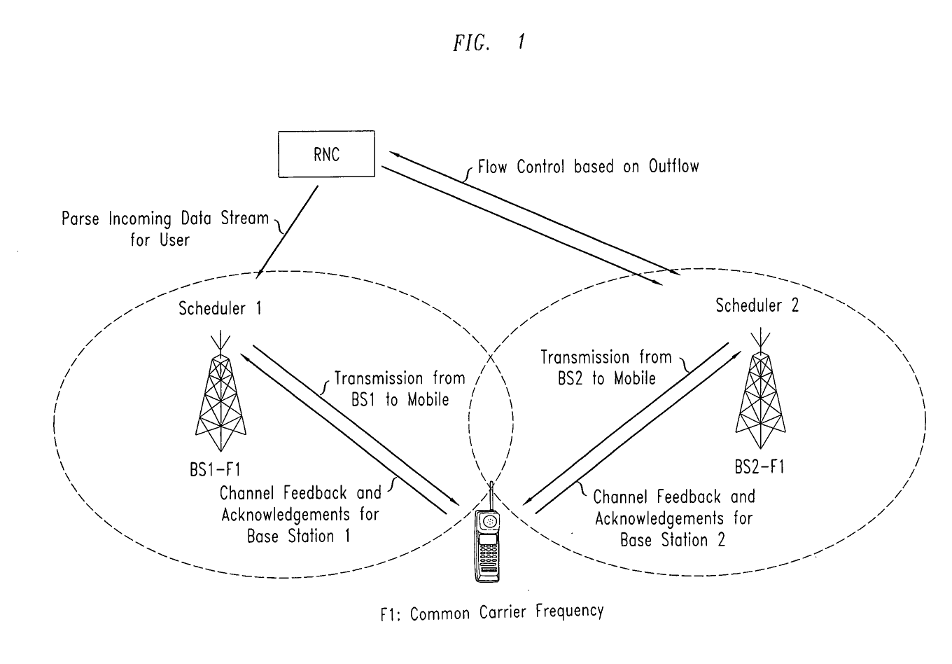

An overall architecture for handoff-region service arrangement, such as described above, is depicted in FIG. 1. As shown in the figure, the data stream associated with a wireless application is parsed at a centralized controller (illustrated as Radio Network Controller, RNC) and fed downstream to two base stations, BS1 and BS2. These base stations each receive channel-state feedback from a served mobile station located in the handoff zone. Schedulers at each base station operate to schedule transmissions as a function of channel-state feedback (among other things), such scheduling being made to the mobile user independently from each base station.

The advantage of such a system is however also a drawback. Users at the cell edge are able to benefit from transmissions from two or more base stations but since these base stations are operating independently, they cannot effectively control the fairness of the transmission resources made available to the user, typically scheduling the handoff-zone mobile station for either more or less transmission resources than would be appropriate under fairness considerations (relative to resources scheduled for other served mobile stations). Thus, for example, when the mobile station is served more often than would be due under fairness considerations, a penalty is imposed on other mobile stations of the system that are served by only one of these base stations, which therefore lose scheduling opportunities and throughput.

Furthermore, it is advantageous to simultaneously schedule data from multiple base stations to a user since the extension of the superposition principle (efficient re-use of common frequency resources) across multiple base stations can increase data rates and throughput. This capability is not present in base station to mobile transmission systems of the current art.

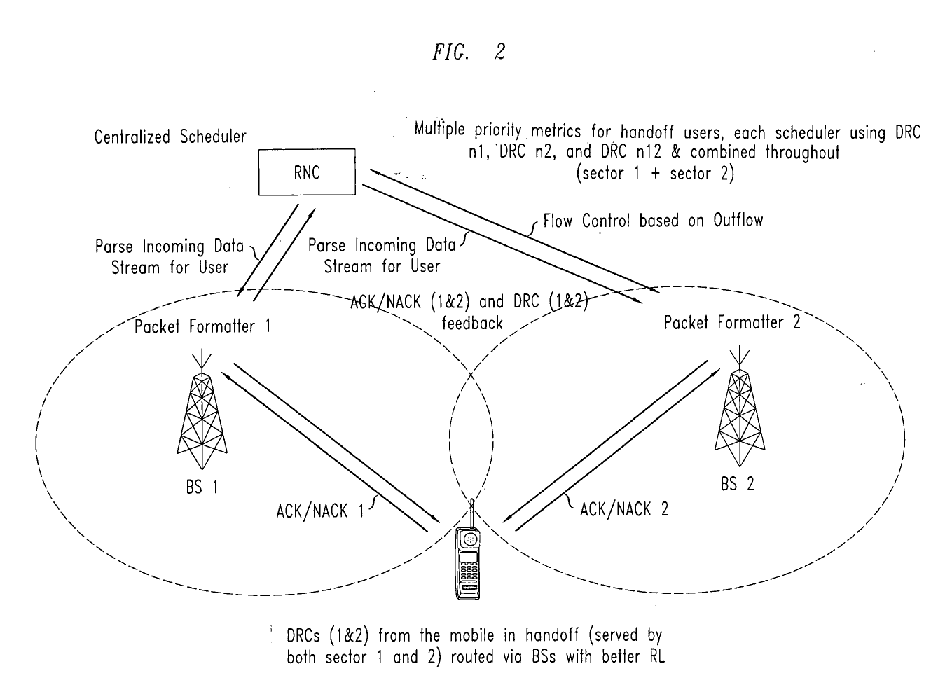

To address these limitations of the current art, the inventors disclose herein a method for centralized scheduling that provides coordinated scheduling for the mobile user from the multiple base stations serving that user. The scheduling methodology of the invention additionally enables superposition of multiple base station transmissions—i.e., the simultaneous scheduling of (and transmission to) a mobile station from multiple base stations using the same frequency resources (e.g., same RF carrier)—for achieving higher rate assignments predicated on interference cancellation at the mobile, thereby even further improving mobile station throughput. An embodiment of the invention is depicted in FIG. 2. Note, however, that while the figure, and the following description are addressed to an illustrative case of the mobile station being served by two base stations, the invention methodology is intended to address multiple base stations serving a given base station. It is further noted that, while the mobile station is generally characterized herein as being located at a cell edge or in a hand-off zone, the invention methodology is applicable to any mobile station served by two or more base stations, regardless of the particular location in a cell for the mobile station.

According to the invention embodiment, one or more centralized schedulers are placed at the radio network controller (RNC), each of which controls (schedules) user transmissions from a contiguous cluster of cells. The cluster size is variable and can range from 2-3 cells to an entire geographic area (hundreds of cells). In the latter case, the preferred case will be one centralized scheduler at each RNC. Each cell cluster is contiguous, and includes at least some users within a cluster that would benefit from transmission from multiple base stations (multi-stream transmission).

In an illustrative embodiment of the invention, the scheduling decisions of the centralized scheduler(s) are implemented by packet formatters located at each base station in the scheduler's cluster. Based on the rate and time-duration assignments made by the centralized scheduler and communicated down to the base station, the packet formatter forms the physical layer packets through appropriate coding and modulation.

The channel feedback from the mobile station, in respect to each of the base stations serving it, is sent via the best air-link to one of the serving base stations and then forwarded over a backhaul link to the centralized scheduler. Acknowledgements of transmissions from each base station are sent to that base station. These are then further relayed to the centralized scheduler.

As in the current art, the mobile station selects the set of serving base stations based on its measurements of forward link (FL) channel quality.

The centralized scheduler is then in a position to prioritize users based on these metrics and from the perspective of a cluster-wide view. Thus, the centralized scheduler operates to not only decide which base station to transmit to the user from, but also to evaluate every viable combination of base stations for concurrent transmission to the mobile station.

The centralized scheduler approach of the invention will generally increase cell-edge user throughput as well as overall system throughput.

Operation of the centralized scheduler embodiment of the invention is hereafter described in the context of an EVDO packet data system. It should be understood, however, that the approach described can be applied to the downlink of any packet data system.

Each mobile station sends requested data rates (DRCs) to each base station that could potentially serve it. For an illustrative mobile station n and base station m, DRCₙₘ represents the data rate for this mobile station requested from base station m.

A proportional fair scheduler operates by determining user priorities. For the case where a given user n can be scheduled from only one base station (e.g., the m^{th} base station),

Priorityₙ=DRCₙₘ/Rₙₘ

where Rₙₘ is the throughput delivered to the user n from base station m. Note that this depiction of a scheduler is provided as an example and should not be construed as a limitation on schedulers implemented according to the method of the invention. Other schedulers, such CR-MAX, may also be readily employed.

For the case of the centralized scheduler of the invention, there are multiple base stations from which the user can be served and, additionally, for users located at or near cell edge, a likelihood of concurrently transmitting to a user from two or more of these multiple base stations. Therefore additional priority metrics must be computed and evaluated for each user-base station combination. Such a priority-based fair scheduling approach for the centralized scheduler is described hereafter as a further embodiment of the invention. Consider, as an illustrative case, scheduling by the centralized scheduler of two base stations BS1 and BS2 that are in a position to serve the user n.

The priority metrics to be determined are

Pₙ₁=DRCₙ₁/Rₙ

Pₙ₂=DRCₙ₂/Rₙ

Pₙ₁₂=DRCₙ₁₂/Rₙ

where Pₙ₁ and Pₙ₂ are the priority metrics for user n to be served at base stations BS1 and BS2, respectively, and Pₙ₁₂ is the priority metric for user n to be served concurrently from both base stations BS1 and BS2; DRCₙ₁ and DRCₙ₂ are the data rates requested by user n from base stations BS1 and BS2, respectively, and DRCₙ₁₂ is the data rate that could be supported by user n if it were to receive concurrent transmissions from both base stations BS1 and BS2. These DRCs are a function of whatever receiver algorithms are employed by the mobile station (e.g., MMSE, with or without Successive Interference Cancellation, etc) and need not be known to the base station. Further, Rₙ is the rate at which user n has been served so far by the network (in the illustrated case, service via both base station BS1 and base station BS2, i.e., Rₙ=Rₙ₁+Rₙ₂).

As explained more fully below, the centralized scheduler of the invention evaluates such metrics for all users in the cluster from a fairness perspective and decides which users to transmit to during a given transmission interval, along with the particular combination of base stations to be applied for each user and the data rates of transmission.

To illustrate the achievement of scheduling fairness according to the method, consider the following case of operation by an exemplary centralized scheduling algorithm. For this case, two base stations are assumed to be serving two users (n=1 or 2) within their coverage area. Each user can be scheduled by either one of the base stations or by both. The priority metrics P₁₁, P₁₂, P₁₁₂and P₂₁, P₂₂, P₂₁₂ are computed. The priority metrics are grouped by feasibility, i.e., P₁₁+P₂₂, P₁₂+P₂₁, P₁₁₂, P₂₁₂ and compared. Note that these four choices correspond to BS 1 serving user 1 and BS 2 serving user 2, BS 2 serving user 1 and BS 1 serving user 2, BS 1 and BS 2 serving user 1 and BS 1 and 2 serving user 2. The maximum accumulated metric determines the schedule, i.e., which set of users are chosen for transmission and from which set of base stations and at what rates. It should be apparent that the exemplary scheduling methodology illustrated here can be extended to n transmissions from n base stations, and, as well, that the superposition of those n transmissions on the same resources can also be made.

Taking the system aggregate served throughput for a given user, Rₙ, into account in the scheduling methodology facilitates the relative fairness of the system to users that are served by only one base station vis-a-vis users who are served by two or more base stations. This is because it lowers the priority of such users when they are served adequately by any one of the serving base stations, i.e., the aggregate throughput increases in this case and the priority metric for the user becomes smaller even at the base station schedulers where the user was not scheduled.

The feature of the invention, and the scheduling fairness methodology implemented therein, wherein the aggregate data rate for a user served by multiple base stations is generally higher than the sum of the individual link rates (DRCₙ₁+DRCₙ₂) is reflected in the DRCₙ₁₂ term, the rate resulting from superposed transmissions from the multiple base stations to a single user. Specifically, the scheduling methodology of the invention contemplates that the two base stations transmit concurrently to the user and that the mobile station uses interference cancellation to sequentially decode the transmissions, cancelling the first reception before decoding the second. Algebraically, this can be expressed as:

DRCₙ₁₂=DRCₙ₁+DRC_{n2/1},

where DRC_{n2/1} is the DRC the mobile station would have reported if it had cancelled out the signal from base station BS 1 or, equivalently, the DRC that would have been sent in the absence of any interfering signal from base station BS 1. Note that DRC_{n2/1} is always greater than DRCₙ₂. This is because the interference term in DRCₙ₂ is the signal from BS 1 while there is no such interference term (or it is highly attenuated) in DRC_{n2/1}.

The scheduler uses the acknowledgement feedback from the mobile station to decide whether or not it is appropriate to consider a base station for scheduling to a user at each scheduling instant.

For example, if a negative acknowledgement is sent by the mobile station for the transmission from base station BS 1, the scheduler does not consider the priority metric Priority_n1, i.e., it takes user n out of the scheduling pool for base station BS 1 for that time instant when base station BS1 would be required instead to retransmit the failed packet to the user.

A positive acknowledgement for this base station's transmission, on the other hand, allows the base station to be considered as a server for the user at the next scheduling instant.

The served throughput Rₙ can be calculated at the centralized scheduler based on the positive acknowledgements and the scheduler's ability to associate these ACKs with specific past transmissions across each base station that served this user. For example, if the base station scheduled a 1 slot transmission at 2.4 Mbps at time t and an ACK was received from the mobile station at time t+2, the centralized scheduler can infer that 4096 bits (1.66 ms/2.4576 Mbps) was successfully transmitted to the mobile from this base station. As an alternative, each base station can compute the throughput Rₙₘ and send it back to the scheduler at periodic intervals.

Herein, the inventors have disclosed a method and system for providing improved data throughput to users located at or near a cell edge in a wireless communication system. Numerous modifications and alternative embodiments of the invention will be apparent to those skilled in the art in view of the foregoing description.

Accordingly, this description is to be construed as illustrative only and is for the purpose of teaching those skilled in the art the best mode of carrying out the invention and is not intended to illustrate all possible forms thereof. It is also understood that the words used are words of description, rather that limitation, and that details of the structure may be varied substantially without departing from the spirit of the invention, and that the exclusive use of all modifications which come within the scope of the appended claims is reserved.

1. A method for scheduling transmission resources to a mobile station served by a plurality of base stations comprising:
operating a centralized scheduler at a network node operative to serve each of the plurality of base stations; and
causing the centralized scheduler to prioritize scheduling of transmission resources to the mobile station as a function of feedback information respecting data received by the mobile station from the plurality of base stations.

2. The method of claim 1 wherein scheduling of transmission resources by the centralized scheduler is arranged to enable simultaneous transmission to the mobile station from each of the plurality of base stations using a common transmission resource.

3. The method of claim 2 wherein the common transmission resource is a same RF carrier.

4. The method of claim 2 wherein the mobile station implements interference cancellation to sequentially decode the simultaneous transmissions, cancelling a first received transmission before decoding a second received transmission

5. The method of claim 1 wherein feedback from the mobile station is provided via a selected RF link between the mobile station and one of the plurality of base stations, and thence via a backhaul link from the one of the plurality of base stations to the centralized scheduler.

6. The method of claim 5 wherein the selected RF link is selected to require minimal transmission power and bandwidth among available RF links.

7. The method of claim 1 wherein the centralized scheduler receives feedback from the mobile station respecting a data rate that the mobile station can support (DRC) and operates to determine scheduling priority metrics for the plurality of base stations as a function of the received DRCs.

8. The method of claim 1 wherein the mobile station feedback information includes acknowledgement parameters.

9. The method of claim 1 wherein the plurality of base stations is at least two.

10. A method for scheduling transmission resources to at least two mobile stations served by a plurality of base stations comprising:
operating one or more centralized schedulers at a network node operative to serve selected ones of the plurality of base stations; and
causing the centralized schedulers to schedule transmission resources to among the plurality of base stations and the at least two mobile station as a function of feedback information respecting data received by the mobile stations from ones of the plurality of base stations.

11. The method of claim 10 wherein scheduling of transmission resources by the centralized schedulers is arranged to enable simultaneous transmission to ones of the mobile stations from selected groupings of the plurality of base stations using common transmission resources in respect to transmissions to particular ones of the at least two mobile stations.

12. A centralized scheduler located upstream from a plurality of base stations comprising:
scheduling means operative to schedule transmission resources from at least two of the plurality of base stations for serving a mobile station; and
processing means operative to receive feedback information respecting data received by the mobile station from the plurality of base stations and to determine transmission resource scheduling for the mobile station as a function of the received feedback information.

13. The centralized scheduler of claim 12 wherein the scheduling means is further operative to enable simultaneous transmission to the mobile station from each of the at least two base stations using a common transmission resource.

14. The centralized scheduler of claim 12 wherein the processing means receives feedback from the mobile station respecting a data rate that the mobile station can support (DRC) and operates to determine scheduling priority metrics for the plurality of base stations as a function of the received DRCs.
